(19) United States
(12) Patent Application Publication
(10) Pub. No.: US 2002/0114758 A1
(43) Pub. Date: Aug. 22, 2002

(54) Production of anhydrous acid from byproduct or waste chlorinated materials

(76) Inventor: Leopoldo Salinas III, Lake Jackson, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/113,022

(22) Filed: Mar. 28, 2002

Related U.S. Application Data
(63) Continuation of application No. 09/630,498, filed on Aug. 2, 2000, now abandoned.
(60) Provisional application No. 60/149,381, filed on Aug. 17, 1999.

(51) Int. Cl. C01B 7/01

(52) U.S. Cl. 423/481

(57) ABSTRACT

A process is described for producing a pipeline-ready anhydrous hydrogen chloride stream from byproduct or waste chlorinated materials, comprising the steps of incinerating the byproduct or waste chlorinated materials, recovering a substantially dry hydrogen chloride product stream from the incineration step, and further drying the substantially dry hydrogen chloride product stream by contact with a desiccant, preferably being dry sulfuric acid.

### CROSS REFERENCE TO RELATED APPLICATIONS

This application is a continuation of U.S. patent application Ser. No. 09/630,498, filed Aug. 2, 2000, which claims the benefit of U.S. Provisional Application Serial No. 60/149,381, filed Aug. 17, 1999.

### BACKGROUND OF THE INVENTION

The present invention relates broadly to processes for the consumption of byproduct and waste chlorinated materials, and especially byproduct and waste chlorinated hydrocarbons. More particularly, the present invention relates to incinerative processes for the consumption of these materials and the production of a hydrogen chloride acid therefrom.

### BRIEF DESCRIPTION OF THE ART

In recent years the disposal of byproduct and waste chlorinated materials has come under increasingly strict regulatory and environmental pressures, and correspondingly has become more expensive to accomplish.

A conventional method of disposal involves the high temperature incineration of the chlorinated hydrocarbon wastes with other chemical wastes, according to a process which is generally depicted in FIG. 1. Thus, chlorinated hydrocarbon waste liquids and gases are supplied with air and non-chlorinated hydrocarbon materials to an incinerator 10, and steam (indicated as stream 13) is generated from the hot incinerator gases in a boiler 12. A lower grade hydrochloric acid stream 14, containing from 10 to 18 weight percent of hydrogen chloride, is produced in an absorber 16 through absorption of hydrogen chloride from the incinerator gases in water (stream 18). Residual hydrogen chloride and chlorine is scrubbed from the gases in a scrubber 20 with an alkali metal hydroxide stream 22, and is neutralized, oxidized and removed in a wastewater stream 24. The scrubbed incinerator gases in stream 26 are then conveyed to the atmosphere via a blower 28 and stack 30.

Where the chemical wastes to an incinerator are substantially comprised of chlorinated hydrocarbon wastes, it has been appreciated for some time that if a more concentrated aqueous hydrochloric acid stream could be economically produced in lieu of the weak hydrochloric acid stream 14, this would be desirable for recovering some of the value which is otherwise lost in the incineration of waste chlorinated hydrocarbons and for offsetting at least a portion of the increasing overall costs of incineration. Accordingly, several processes have been proposed and are commercially available or known for producing 20 to 35 weight percent hydrochloric acid as well as still more valuable anhydrous acid. Illustrative processes are shown and summarized in Kolek, “Hydrochloric Acid Recovery Process”, Chemical Engineering Progress, Vol. 69, No. 2, pp. 47-49 (February 1973). A process as developed and employed by the former Hoechst AG has also been described in Ertl, “Incineration Plant for Liquid and Gaseous Chlorinated Wastes”, Proceedings of the 1997 International Conference on Incineration and Thermal Treatment Technologies (1997), and this process is described in some detail below with respect to FIG. 2.

### SUMMARY OF THE PRESENT INVENTION

Unfortunately, however, the “anhydrous” hydrogen chloride recovered by the known processes described in these publications can still contain appreciable amounts of water, and can accordingly present some rather severe corrosion problems downstream. Corrosion-resistant materials are only a partial solution, especially where an extensive anhydrous HCl piping network is already in place, for example, for conveying anhydrous hydrogen chloride to an associated manufacturing facility for making vinyl chloride monomer (VCM) from ethylene through oxychlorination to 1,2-dichloroethane (or, EDC), and then cracking the EDC to make VCM. Additionally, trace quantities of water in the “anhydrous” vapor phase HCl can cause significant corrosion to compressors, rendering them impractical.

The present invention consequently relates to the provision of additional drying of an anhydrous acid product recovered from the incineration of chlorinated materials, to an extent whereby the anhydrous acid can be compressed and pipelined to a remote, associated EDC/VCM manufacturing facility without experiencing excessive corrosion of the transport apparatus as a whole. In general, the moisture content of the anhydrous hydrogen chloride product after drying will be about 0.5 parts per million by weight or less, preferably will be about 0.3 parts per million by weight or less, and most preferably will be about 0.15 parts per million by weight or less. A preferred application will be in the context of drying anhydrous acid produced according to a process of the general type shown in FIG. 2, and especially by the use of sulfuric acid as a desiccant.

### BRIEF DESCRIPTION OF THE DRAWINGS

FIG. 1 is a schematic depiction of a conventional incineration process and apparatus for the incineration of waste chlorinated hydrocarbons, in which weak hydrochloric acid and steam are produced for use elsewhere.

FIG. 2 depicts an incineration process which has been developed and commercially employed and licensed by the then-Hoechst AG for incinerating waste chlorinated hydrocarbons from an associated ethylene dichloride (EDC)/vinyl chloride monomer (VCM) production facility, and which contemplates the recovery of anhydrous hydrogen chloride as a feed and raw material for the oxychlorination process in the EDC/VCM production facility.

FIG. 3 schematically shows a sulfuric acid drying process in a preferred embodiment, for further drying the anhydrous acid produced in a process of the type shown in FIG. 2 and for making the final anhydrous acid product suitable for pipelining to a remote EDC/VCM manufacturing facility.

### DETAILED DESCRIPTION OF THE DRAWINGS AND OF THE PREFERRED EMBODIMENTS OF THE INVENTION

A preferred application of the process of the present invention will be for the incineration of a stream substantially comprised of byproduct and waste chlorinated materials and especially chlorinated hydrocarbons, for example, in the form of heavy and light distillation fractions from a chlor-alkali manufacturing process, from the manufacture of ethylene dichloride and vinyl chloride monomer or of chlorinated solvents, or from the manufacture of olefin oxides via a chlorohydrin intermediate, polychlorinated biphenyl-contaminated transformer oils and heat transfer fluids, chlorinated pesticide and herbicide wastes and waste chlorinated solvents. In general, the feed to the incineration process will contain more than about 15 percent by total weight of chlorine, but preferably will contain at least about 30 percent, more preferably about 40 percent by weight and most preferably will contain about 50 percent or more by total weight of chlorine.

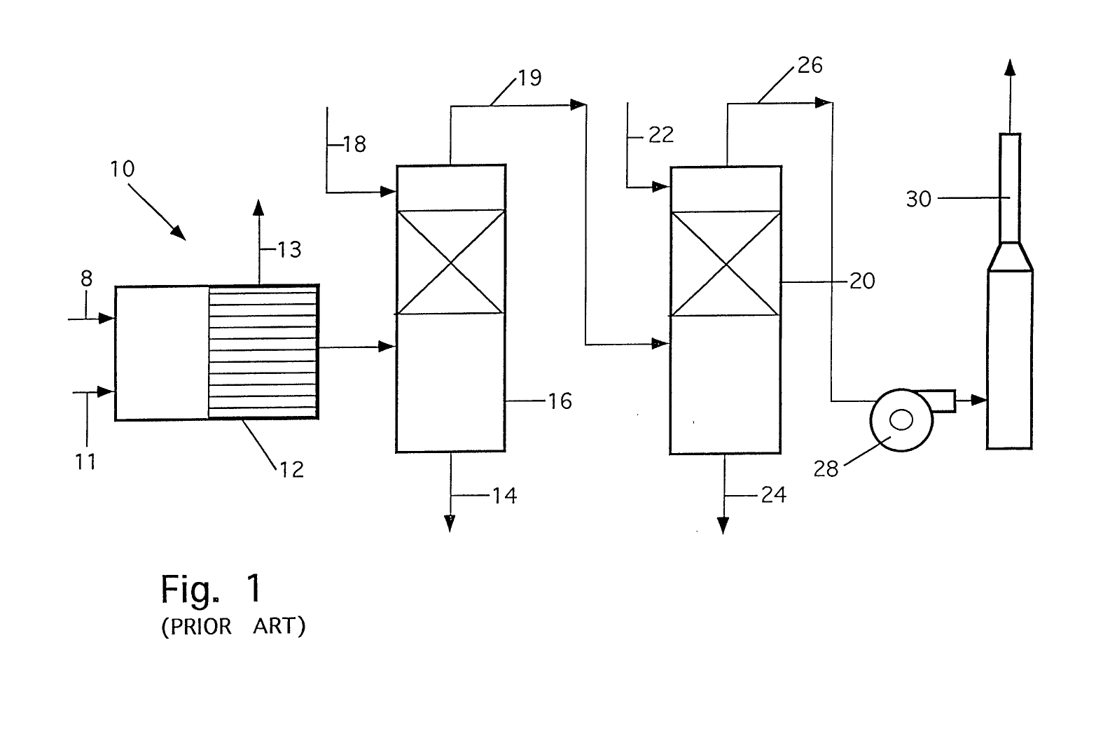

As has been mentioned previously, one method known to the art for disposing of such materials is a shown in FIG. 1. Referring now to FIG. 1, and as summarized above, chlorinated hydrocarbon waste liquids and process vents are supplied in a stream 8 to a conventional incinerator 10 with air and optionally additional non-chlorinated hydrocarbon materials, for example, methane, in a stream 11. The heat of combustion is employed in boiler 12 for generating steam 13, and a cool effluent gas stream is then passed to absorber 16 wherein hydrogen chloride in the effluent gas is absorbed into water supplied by stream 18 and produces a weak hydrochloric acid stream 14 containing generally from about 10 to about 18 percent by weight of hydrogen chloride. Any residual hydrogen chloride remaining in the overheads 19 from the absorber 16 is neutralized in a scrubber 20 with alkali metal hydroxide (typically caustic soda) supplied in stream 22, and disposed of in a waste water stream 24. The remaining incineration gases 26 are discharged via blower 28 and a stack 30.

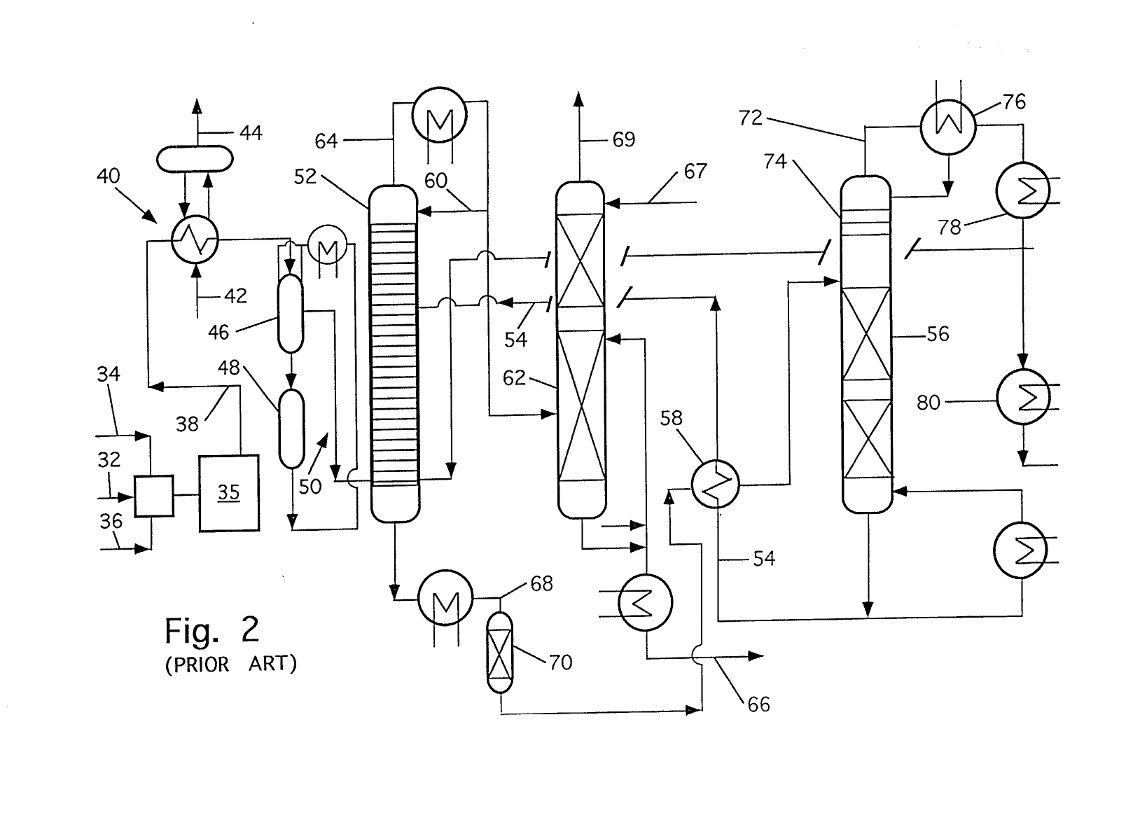

A commercial incineration process developed by the then-Hoechst AG for incinerating chlorinated hydrocarbon wastes in particular is shown in FIG. 2, and recovers the chlorine value of the chlorinated hydrocarbon wastes in the form of a gaseous anhydrous hydrogen chloride product stream.

A summarized in the Ertl article referenced above, liquid chlorinated hydrocarbon wastes in stream 32 are fed to a burner nozzle via residue filters, with a gaseous chlorinated hydrocarbon waste 34 being fed directly to the incineration chamber 35. The waste is atomized with compressed air from stream 36 in the burner nozzle and incinerated at about 0.2 bars, gauge and 1250 degrees Celsius with from 4 to 5 percent of excess oxygen. To maintain or limit the incinerator temperature, supplemental heating with natural gas or addition of water or preferably aqueous hydrochloric acid to the incinerator chamber, respectively, are suggested.

The flue gas 38 from the incinerator passes through a boiler 40 wherein boiler feed water 42 is converted to steam 44 and the temperature of the flue gases decreased to about 300 degrees Celsius. The steam generated is fed into the steam system of an associated EDC/VCM plant at a pressure of 8 bars absolute, and a small fraction of the boiler feed water 42 is purged to limit the salt concentration in the steam drum.

The flue gas 38 leaving the boiler 40 is then quenched with hydrochloric acid in a quench chamber 46 to approximately 60 to 70 degrees Celsius, with a residue filter being provided in the quench recycle system 48 to remove solids (for example, ash and metals) from the quench system.

The flue gas 50 exiting the quench system is then supplied to an absorber column 52 equipped with bubble cap trays. Aqueous hydrochloric acid at an atmospheric pressure azeotropic composition is supplied in a stream 54 from a desorber 56, via heat exchangers 58 at a temperature of about 90 degrees Celsius. The HCl concentration increases in the absorber 52 from its azeotropic value to a value of about 25 to about 28 percent by weight at the bottom of the absorber 52. The remaining HCl in the gas is removed, except for small amounts, in the upper part of the absorber 52 where the gas therein is contacted with condensate in stream 60. Before entering scrubber 62, water vapor in the off-gas 64 from the absorber 52 is reduced in the top condenser to a value corresponding to a temperature of about 35 degrees Celsius.

The scrubber 62 is described as being comprised of a lower section wherein most of the remaining HCl and free chlorine in the off-gas 64 is neutralized with 18 weight percent sodium hydroxide in water (stream 65), and then removed in a wastewater stream 66. Traces of HCl still left in the gas phase are still further reduced in an upper section of the scrubber 62 by absorption into demineralized water via stream 67, and the flue gas 69 emitted to the atmosphere at about 25 degrees Celsius.

The acid stream 68 from the bottom of the absorber 52, containing from about 25 to about 28 weight percent of hydrogen chloride in water, is passed through filtration and ion exchange in vessel 70 to remove residual solids and metal chlorides, before entering the desorber 56 at about 120 degrees Celsius. The desorber 56, which operates at a pressure of 4.5 bars, gauge, in contrast to the various other apparatus operating at atmospheric pressure, functions to distill the stream 68 and produce the aqueous, azeotropic HCl stream 54 and an overhead stream 72 which, after passing through a demister 74 at the top of desorber 56, is dried through two condensers 76 and 78. The second condenser 78 employs refrigeration to reduce the temperature of the gas stream 72 to −12 degrees Celsius, whereupon a portion 79 of the resulting anhydrous hydrogen chloride gas stream is recycled to the absorber 52 (although the recycle stream 79 can preferably be omitted, the apparent purpose of this stream 79 being only to keep the desorber 56 running when the oxychlorination portion of an associated EDC/VCM facility is not in operation). The remainder, in the form of anhydrous product stream 81, is heated in exchanger 80 to a temperature in excess of the dew point (typically being about 60 degrees Celsius), and in Hoechst's process as. described in the Ertl article is then supplied to an adjacent EDC/VCM manufacturing facility.

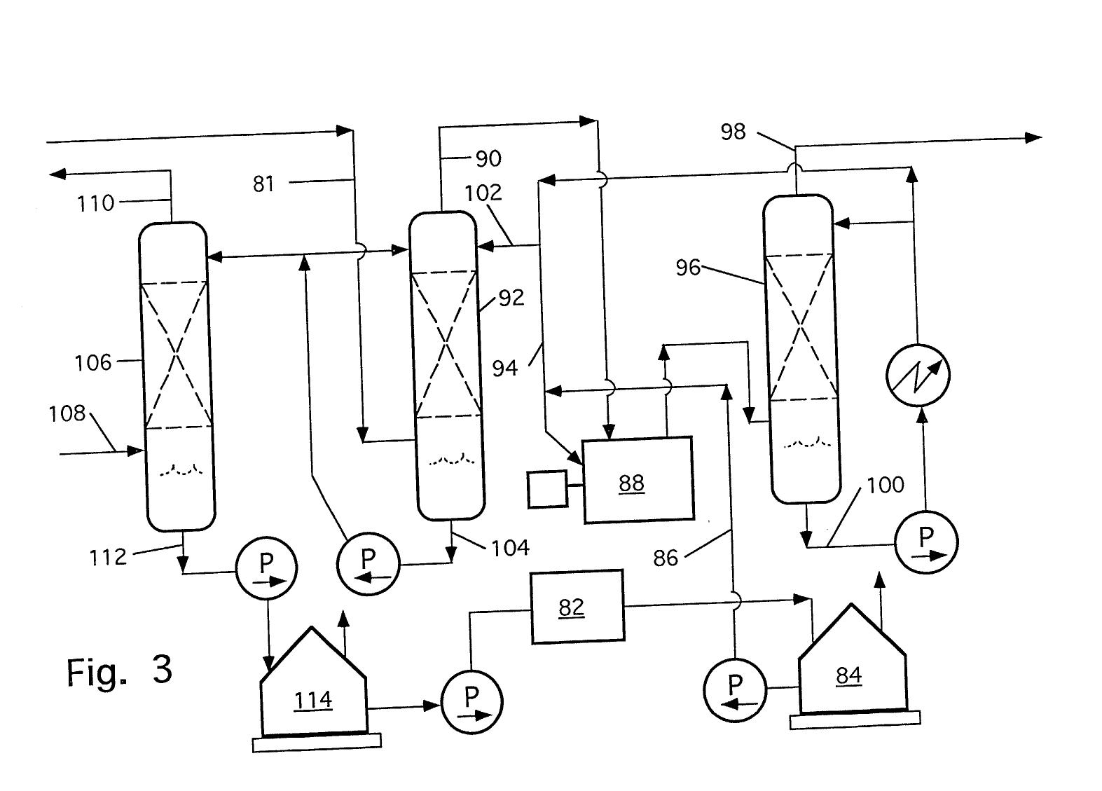

In the improvement provided by the present invention, as shown in FIG. 3, sulfuric acid drying is preferably employed on the anhydrous acid product stream 81 for enabling the anhydrous acid to be compressed and pipelined to another location. Dry sulfuric acid is delivered in the embodiment of FIG. 3 from a truck loading facility 82 to a vent-equipped dry sulfuric acid tank 84. The dry sulfuric acid 86 is then pumped to a liquid ring compressor 88, where the dry sulfuric acid 86 is combined with a partially dried hydrogen chloride overheads stream 90 from a first packed absorber column 92 which receives the anhydrous hydrogen chloride product stream 81, and with a recycle, partially wet sulfuric acid stream 94 from a second packed absorber column 96. The partially dried HCl 90 from the first absorber column 92 is then further dried in the second packed absorber column 96, to provide the desired pipeline-ready anhydrous HCl vapor stream 98 overhead and a partially wet sulfuric acid bottoms stream 100 that is refluxed in part and that also provides the recycle, partially wet sulfuric acid stream 94 supplied to the compressor 88. Still a third part 102 of the partially wet sulfuric acid bottoms stream 100 is used in the first packed absorber column 92, for contacting the higher water content HCl product stream 81 and for drawing additional water therefrom to produce the partially dried HCl overheads stream 90 then fed to the compressor 88 and to the second packed absorber 96. The fully wet sulfuric acid emerges as a bottoms stream 104 from the first packed absorber 92, is recycled in part to the top of the first packed absorber column 92 and in part is supplied to a packed stripper column 106 which uses dry air in stream 108 to pull residual HCl from the wet sulfuric acid overhead in a vents stream 110, the vents stream 110 thereafter being neutralized in a conventional vent scrubber (not shown). The HCl-stripped, wet sulfuric acid 112 from the stripper 106 is then stored in tank 114 for shipment, drying and reclaimation by a merchant supplier of dry sulfuric acid. Those skilled in the art will recognize that other arrangements of apparatus can be employed for carrying out the preferred sulfuric acid drying of the HCl stream 81, including the use for example of a single absorber with several stages as opposed to the two absorbers 92 and 96.

What is claimed is:

1. A process for producing a pipeline-ready anhydrous hydrogen chloride stream from byproduct or waste chlorinated materials, comprising the steps of:
incinerating the byproduct or waste chlorinated materials;
recovering a substantially dry hydrogen chloride product stream from the incineration step; and
further drying the substantially dry hydrogen chloride product stream by contact with a desiccant.

2. A process as defined in claim 1, wherein the desiccant is a liquid desiccant.

3. A process as defined in claim 2, wherein the desiccant is dry sulfuric acid.

4. A process as defined in claim 3, wherein recovering the substantially dry hydrogen chloride product stream comprises:
absorbing hydrogen chloride in the gaseous effluent from the incineration step into an azeotropic composition aqueous hydrochloric acid stream, to provide a concentrated aqueous hydrochloric acid stream having a hydrogen chloride concentration above the azeotropic concentration of hydrogen chloride in water at the absorber pressure; and
desorbing hydrogen chloride from the concentrated aqueous hydrochloric acid stream under elevated pressures, to produce a) the substantially dry hydrogen chloride product stream overhead and b) the azeotropic composition aqueous hydrochloric acid stream provided at least in part to the absorption step.

5. A process as defined in claim 1, wherein the substantially dry hydrogen chloride product stream is characterized by a water content of less than about 0.5 parts per million by weight.

6. A process as defined in claim 5, wherein the substantially dry hydrogen chloride product stream is dried to a water content of less than about 0.3 parts per million by weight.

7. A process as defined in claim 6, wherein the substantially dry hydrogen chloride product stream is dried to a water content of less than about 0.15 parts per million by weight.
